(19) United States
(12) Patent Application Publication
(10) Pub. No.: US 2019/0279139 A1
(43) Pub. Date: Sep. 12, 2019

(54) SYSTEMS AND METHODS FOR FACILITATING COLLABORATIVE TIME MANAGEMENT

(71) Applicant: Ephemeryde, Inc., Salt Lake City, UT (US)

(72) Inventor: Eric Hofer, Salt Lake City, UT (US)

(21) Appl. No.: 16/293,287

(22) Filed: Mar. 5, 2019

Related U.S. Application Data
(60) Provisional application No. 62/639,401, filed on Mar. 6, 2018.

(51) Int. Cl. G06Q 10/06; G06Q 10/10; G06F 3/0482

(52) U.S. Cl. CPC G06Q 10/063116; G06F 3/0482; G06Q 10/1097

(57) ABSTRACT

Systems and methods for collaborative time management. In some embodiments, the system may allow a group of users to manage their schedules by coordinating their respective scheduling/calendars with others, such as coworkers, a group of friends, or family members. The system may be configured to facilitate scheduling of an event by automatically tracking shared available time slots for a group of invitees during a predetermined time frame and/or displaying available date/time slots based upon a set of parameters, such as users in a particular group and/or one or more requested and/or possible time slots by an organizing user. Some embodiments may further provide for tracking and/or visualizing potential shared available time slots based upon the flexibility of conflicts or potential conflicts during the requested time frame(s).

### RELATED APPLICATIONS

This application claims priority to U.S. Provisional Patent Application No. 62/639,401 filed Mar. 6, 2018 and titled “SYSTEMS AND METHODS FOR FACILITATING COLLABORATIVE TIME MANAGEMENT,” which application is incorporated herein by reference in its entirety.

### SUMMARY

Systems and methods are disclosed herein that related to smart time management. For example, the inventive concepts disclosed herein may be used to provide systems and/or methods to allow a group of users to manage their time by way of an intuitive and interactive graphical user interface display. In preferred embodiments, the inventive systems and/or methods may further allow users to coordinate their respective scheduling/calendars with others, such as coworkers, a group of friends, family members, and the like, by, for example, modifying the graphical user interface to look for shared free time during a predetermined time frame and display available date/time slots based upon a set of parameters, such as users in a particular group and/or one or more requested and/or possible time slots by an organizing user.

Some embodiments may also, or alternatively, categorize and/or allow users to categorize certain events according to the possibility of them being rescheduled. For example, some embodiments may allow users to categorize, or may automatically categorize based upon certain criteria, certain events as either “hard” or “soft.” “Hard” events may comprise events that cannot, or likely cannot, be rescheduled to accommodate a meeting request. “Soft” events may comprise events that may be reschedulable.

In preferred embodiments and implementations, a user may therefore be provided with an indication, such as a visual display, of available time slots during which each of a plurality of requested participants/invitees could potentially get together for a mutual event, whether in person or by way of remote collaboration. In some such embodiments and implementations, the visual display or other indication may provide information indicating time slots during which all users are available and time slots during which all users are potentially available. In other words, by factoring in “hard” or “soft” conflicts, or otherwise taking into account the changeability of conflicts, users may be presented with all available options for ensuring that the group of users is able to collaborate.

In some embodiments and implementations, for example, the display may provide a first color, say green, for time windows in which all invitees have no conflicts, whether hard or soft, a second color, say yellow, for time windows in which some invitees have a conflict that may be changeable, and a third color, say red for time windows in which one or more invitees have a hard or non-changeable conflict.

In a more particular example of a system for facilitating collaborative time management, the system may comprise a server configured to communicate with a plurality of users by way of computing devices, such as mobile smartphones. The server may be configured to receive input from at least a subset of the users comprising scheduling data. The server may further be configured to transmit data to one or more meeting organizers or potential meeting organizers of the plurality of users to allow the meeting organizer(s) to visualize one or more available, or potentially available, time windows for the meeting. In some embodiments, the server may further be configured to receive information regarding a potential meeting request from one or more of the users and compare scheduling data from each of the invitees for the meeting request to provide an indication of availability for the meeting to the meeting organizer(s). This information may comprise, for example, a list of potential invitees. Upon receiving this information, the server may compare schedules of each of the potential invitees and transmit data to the meeting organizer(s) to allow for conveying information about the potential availability of the group for the proposed meeting. The information sent to the server may, in some embodiments, further comprise one or more time frames during which the meeting may take place. However, alternative embodiments are contemplated in which simply the identities of the possible invitees are provided without a selected time frame or frames.

In preferred embodiments, the system may be configured to provide the indication of availability for the meeting to the meeting organizer(s) by displaying on a display unit, such as a display screen of a mobile computing device, a representation of a first window of time comprising a first graphical user interface display feature that indicates one or more users are unavailable and a representation of a second window of time comprising a second graphical user interface display feature that indicates one or more users are available.

For example, some embodiments may provide for display of one or more time windows by way of circular design, which may display, for example, day, week, month, and/or year views as selected by a user. With respect to such embodiments, the first graphical user interface display feature may comprise, for example, a portion of the circular calendar display that differs from other portions of the circular calendar display. For example, time windows during which each possible invitee in the group are available (corresponding to the “first graphical user interface display feature”) may be shown in a different color and/or be highlighted or otherwise emphasized. Thus, as a more specific example, the alphanumeric characters on the display (e.g., times of the day, days of the week, days of the month) may be highlighted and/or displayed in a distinct color, such as green, to indicate shared available times/days. In some embodiments, an analog indication of time frames may be provided, either in addition or as an alternative to the alphanumeric character display feature. For example, a portion of the display corresponding to a time frame, such as an arc corresponding with a portion of a circular calendar display, may be highlighted or otherwise altered to provide a (preferably immediate) visual indication of the distinction between this time frame and other time frames, as described in greater detail below.

Similarly, the alphanumeric characters on the display may be highlighted and/or displayed in a distinct color, such as red or black, to indicate unavailable times/days (corresponding to the “second graphical user interface display feature”). In some embodiments, an analog indication of time frames may be provided, either in addition or as an alternative to the alphanumeric character display feature, as previously mentioned and described in greater detail below.

In some such embodiments, the alphanumeric characters on the display and/or an analog indication of time frames on the display may be highlighted and/or displayed in a distinct color, such as orange or yellow, to indicate possibly available times/days. As alluded to briefly above and described in greater detail below, this indication may correspond with, for example, “soft” conflicts and/or events that may be changeable. In this manner, a user can easily and conveniently be provided with a visual indication of the availability or potential availability of each of a plurality of users, such as a group of coworkers collaborating on a project or group of friends looking to get together for dinner, to improve scheduling efficiency and/or successes.

Some embodiments and implementations may offer event-based communication, such as chats with each invited and/or confirmed attendee of a particular event. Such communications may take place between all members of the event group or between an individual or subset of the members of the group.

Some embodiments and implementations may further provide for integration with third-party entities, such as businesses wishing to advertise and/or otherwise communicate with one or more group members based upon products and/or services that the members of the event-based group may find interesting. For example, event-based communications may include messages, which may in some embodiments be incorporated into the event-based communication features amongst group members, from such entities/sponsors. Such communications may be based upon and/or triggered by, for example, the location of the event (based upon GPS tracking in some embodiments), the current location of one or more members of the group, the type of event, the content of previous event-based communications between members of the group, user preferences, etc.

In a example of a specific method for facilitating collaborative time management, the method may comprise receiving schedule data from a plurality of users. The schedule data may comprise one or more scheduled events for each of the plurality of users and time periods associated with the one or more scheduled events. Event organizing data for an event may then be received from an event organizer, the event organizing data comprising one or more time windows and one or more event invitees for the event. The schedule data may be compared with the event organizing data to identify one or more shared available time windows for the event, after which graphical data may be transmitted for display on a computing device, the graphical data comprising an image allowing the event organizer to visualize each of the one or more shared available time windows concurrently on a display screen of the computing device.

In some implementations, the schedule data may comprise at least two types of scheduled events for at least one of the plurality of users, which event types may be categorized according to the likelihood of being able to reschedule a scheduled event by a user. For example, in some embodiments, the at least two types of scheduled events may comprise hard scheduled events that cannot be rescheduled and soft rescheduled events that may be rescheduled. Thus, the step of comparing the schedule data with the event organizing data to identify one or more shared available time windows for the event may comprise comparing the schedule data with the event organizing data to identify one or more soft available time windows during which one or more of the plurality of users has a soft scheduled event. In some such implementations, the image may be such that a user can visualize any unavailable time windows, any soft available time windows, and any available time windows for the event.

In some implementations, a circular calendar display may be generated for each of the plurality of users, each of the circular calendar displays comprising a visual indication of a respective user's scheduled events for a predetermined period of time.

In some implementations, the image may also comprise a circular calendar display comprising a visual indication of each of the one or more shared available time windows. In some such implementations, the circular calendar display of the image may comprise a plurality of concentric graphical features, wherein each of the plurality of concentric graphical features conveys information relating to a distinct time frame, such as time of date, days of the week, weeks of the month, months of the year, etc.

In another example of a method for facilitating collaborative time management, the method may comprise receiving schedule data from a remote user system. The schedule data may comprise one or more scheduled events for each of a plurality of users and time periods associated with the one or more scheduled events. The method may further comprise receiving a request to organize an event from an event organizer and generating a response to the request, the response comprising a visualization derived from the schedule data and the request. In some implementations, the visualization may comprise a single image comprising non-textual information from which any shared available time windows for the event can be derived. The response may be transmitted to a user where it can be displayed on a mobile device, computer, or other computing device comprising a display.

In some implementations, the step of transmitting the response to a user may comprise transmitting the response to the event organizer. In some implementations, the step of transmitting the response to a user may comprise transmitting the response to a remote computing device.

The image may comprise a circular time display, such as a circular time display comprising a plurality of concentric layers from which distinct calendar-related information can be derived.

In a specific example of a system for facilitating collaborative time management, the system may comprise a computing device comprising a processor, the computing device configured to communicate with a plurality of user devices. The system may further comprise a database configured to store data records for a plurality of users associated with the plurality of user devices, wherein the data records comprise event schedules for one or more of the plurality of users. The system may further comprise an event organizing module configured to receive a request for scheduling an event from an event organizer, wherein the event organizing module is configured to compare event organizing data within the request comprising one or more time windows and one or more event invitees for the event with data records for each of the one or more event invitees and to identify one or more shared available time windows for the event. An event schedule visualization module may also be included, which module may be configured to generate a visualization comprising an image from which any shared available time windows for each of the invitees to the event can be derived.

In some embodiments, the event organizing module may be configured to compare at least two types of scheduled events for at least one of the plurality of user devices. The at least two types of scheduled events may be categorized according to the likelihood of being able to reschedule a scheduled event by a user.

In some embodiments, the event organizing module may be configured to compare hard scheduled events for each of the event invitees that cannot be rescheduled and soft rescheduled events for each of the invitees that may be rescheduled. In some such embodiments, the visualization may comprise a visual indication of any unavailable time windows, any soft available time windows, and any available time windows for the event.

Some embodiments may further comprise an analytics module configured to receive a request for an analytics report from a report requesting user and generate an analytics report comprising data relating to a plurality of prior events for the report requesting user. In addition, some embodiments may further comprise a messaging module configured to allow each of the one or more event invitees to send messages relating to the event.

The features, structures, steps, or characteristics disclosed herein in connection with one embodiment may be combined in any suitable manner in one or more alternative embodiments.

### BRIEF DESCRIPTION OF THE DRAWINGS

Non-limiting and non-exhaustive embodiments of the disclosure are described, including various embodiments of the disclosure with reference to the figures, in which:

FIG. 1 is a schematic diagram illustrating a system for collaborative time management according to some embodiments;

FIG. 2 is a diagram illustrating how some embodiments and implementations may compare multiple user schedules to provide information about available time slots for a meeting or other joint event;

FIG. 3 is a flow chart illustrating a method for collaborative time management according to some implementations;

FIG. 4 is a screenshot of a “month view” of a user interface for implementing one embodiment of a collaborative time management system;

FIG. 5 is a screenshot of a “week view” of a user interface for implementing one embodiment of a collaborative time management system;

FIG. 6 is a screenshot of a “day view” of a user interface for implementing one embodiment of a collaborative time management system;

FIG. 7 is a screenshot of a scheduling or shared free time view of a user interface for implementing one embodiment of a collaborative time management system;

FIG. 8 is an alternative screenshot of a scheduling or shared free time view of a user interface for implementing one embodiment of a collaborative time management system;

FIG. 9 is a screenshot of a “date picker” view of a user interface for implementing one embodiment of a collaborative time management system;

FIG. 10 is a screenshot of a “time picker” view of a user interface for implementing one embodiment of a collaborative time management system;

FIG. 11A is a screenshot of an event-based communication user interface for implementing one embodiment of a collaborative time management system showing all users who are scheduled to participate in an event;

FIG. 11B is another screenshot of an event-based communication user interface for implementing one embodiment of a collaborative time management system showing a communication with a particular user who is scheduled to participate in an event;

FIG. 12A is a screenshot of a listing of events of a user interface for implementing one embodiment of a collaborative time management system showing communications based upon each event in the listing of events;

FIG. 12B is another screenshot of an event-based communication user interface for implementing one embodiment of a collaborative time management system showing a communication with a particular user who is scheduled to participate in an event;

FIG. 13 is a schematic diagram of a system for collaborative time management according to some embodiments comprising an interface with a third-party associate;

FIG. 14 depicts three additional screenshots of a user interface for implementing one embodiment of a collaborative time management system;

FIG. 15 is a flow chart illustrating another example of a method for collaborative time management according to some implementations;

FIG. 16 is another flow chart illustrating yet another example of a method for collaborative time management; and

FIG. 17 is another schematic diagram of a system for collaborative time management according to other embodiments.

### DETAILED DESCRIPTION

A detailed description of apparatus, systems, and methods consistent with various embodiments of the present disclosure is provided below. While several embodiments are described, it should be understood that the disclosure is not limited to any of the specific embodiments disclosed, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Methods and systems are disclosed herein relating to systems and methods for improving collaboration between a plurality of users by facilitating time management display and/or scheduling between one or more such users. The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

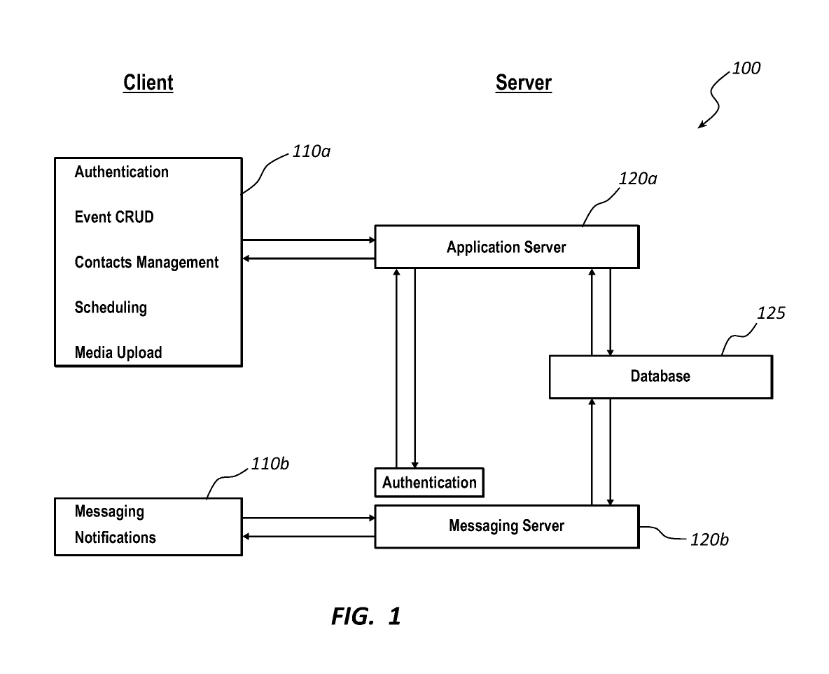

FIG. 1 depicts an example of a system 100 for collaborative time management according to some embodiments. As shown in this figure, one or more client devices, such as client device 110a, may be configured to communicate with one or more servers and/or databases, such as application server 120a, messaging server 120b, and database 125. Client device 110a may comprise any computing device suitable for implementing the inventive systems and/or methods and preferably comprising a processor, including but not limited to a personal computer, a laptop computer, a desktop computer, a notebook or tablet, a smartphone, and the like.

Communication between the client device(s) and the server(s) may take place over a network, which may comprise, for example, the Internet, a local area network, a virtual private network, a mobile network, and/or any other communication network utilizing one or more electronic communication technologies and/or standards (e.g., Ethernet or the like). Information pertaining to the system 100 may be presented to various clients/users in an application operating on a client device 110a. This application may comprise, for example, a general-purpose web browser application, a special-purpose application, such as a mobile phone application, or the like.

Client device 110a may comprise various modules, elements, or other functional sub-parts configured to implement various aspects of certain embodiments of the invention as desired. For example, as depicted in FIG. 1, client device 110a may be configured to communicate with application server 120a to provide user authentication, creation, reading, updating, and/or deleting of events, such as meetings involving several users, management of contacts with other users in system 100, scheduling of meetings or other events with other users, and/or uploading/downloading of media.

FIG. 1 also depicts a second client device 110b being used for messaging with other users. In preferred embodiments and implementations, such messaging may comprise event-based messaging, as described in greater detail below. However, it should be understood that, in preferred embodiments and implementations, second client device 110b may be a different portion or sub-module of an application running on client device 110a. In other words, a single client device may perform all of the functions of client devices 110a and 110b, in which case elements 110a and 110b may be considered sub-elements or modules of a single application running on a single client device 110.

Client device/sub-module 110b may be configured to communicate with a messaging server 120b. Messaging server 120b may, in turn, be configured to communicate with application server 120a. However, it is contemplated that servers 120a and 120b may be physically distinct servers or, alternatively, may be sub-elements or modules of a single server or other suitable computing device preferably comprising a processor.

One or more databases 125 may be communicatively coupled with servers 120a and 120b. Database(s) 125 may be configured to store various records or other data elements associated with system 100, such as records of user accounts, event schedules, calendars, communication records, etc. Again, as those of ordinary skill in the art will appreciate, database 125 may, in some embodiments, be part of the same physical computer/machine as one or both of servers 120a and 120b or, may be a separate computer/machine specifically configured for data storage.

As also depicted in FIG. 1, in some embodiments, authentication steps and/or elements may take place and/or be provided between application server 120a and one or more user devices 110 and between application server 120a and messaging server 120b. Authentication may take place by any means known or otherwise available to one of ordinary skill in the art, such as by use of a digital signature or other credentials provided by users.

Some embodiments may also, or alternatively, be configured to allow for use of multiple accounts or contact “spheres” (e.g., sub-groups). For example, a public sphere and/or account may provide for creation of a profile and generation of public events. Similarly, a private sphere and/or account, such as a work account, may provide for creation of a profile and generation of private events that, for example, only users employed by a particular company or belonging to a particular organization or group may see, be invited to, or otherwise interact with.

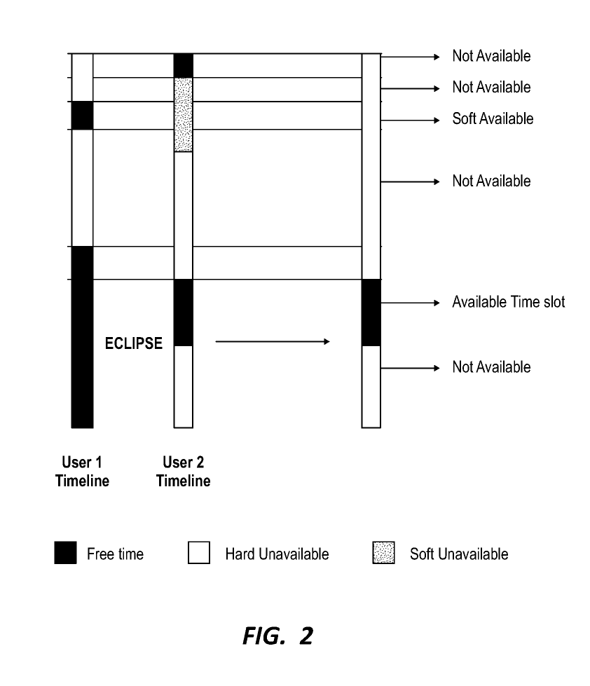

FIG. 2 is a diagram illustrating schematically a functionality of preferred embodiments and implementations that allows for automated comparison of multiple user schedules to provide information about available time slots for a meeting or other event to a scheduler of said event. As shown in this figure, the system may be configured to, upon receiving a request to show available time slots for scheduling an event from a scheduler/organizer, obtain schedule data from multiple users, and provide feedback to the scheduler/organizer regarding available time slots for the event.

As discussed in greater detail below, in some embodiments, the system may be configured to provide feedback relating to both “hard” available/unavailable time slots and “soft” available/unavailable time slots for the event. In other words, a “hard” conflict or event may comprise events that cannot, or likely cannot, be rescheduled to accommodate a meeting/event request. By contrast, a “soft” conflict or event may comprise events that are tentative and/or may be subject to cancellation and/or rescheduling.

Thus, as shown in FIG. 2, the system may be configured to compare a timeline of a first user (User 1) with a timeline of a second user (User 2). In some embodiments, this comparison may simply look for time windows in which there are currently no overlaps/conflicts between the two user schedules (preferably during a time frame or frames indicated by the organizer). Thus, such embodiments, may result in the identification of an available time slot, as indicated in FIG. 2.

In other embodiments, the flexibility of the various user schedules may be taken into account. Thus, as previously alluded to, some embodiments may rely on comparison of two or more user schedules/timelines according to “soft” events and “hard” events. Thus, as also depicted in FIG. 2, the comparison of the two user timelines in such embodiments may result in identification of not only the available time slot previously mentioned, but also a second time slot that is “soft” available, meaning that one of the users (User 2 in this case) has a soft conflict during this time slot.

Various alternatives are contemplated based upon this disclosure, however. For example, in some embodiments, more than two types of conflicts may be taken into account, such as allowing users to rate the possibility of rescheduling a conflict by more than a binary “hard” or “soft.” However, the simplicity of this binary approach may be preferable for certain applications. In addition, although only two users are depicted in FIG. 2, it should be understood that preferred embodiments may be configured to compare schedules of any number of users, such as each employee within a particular company, for example.

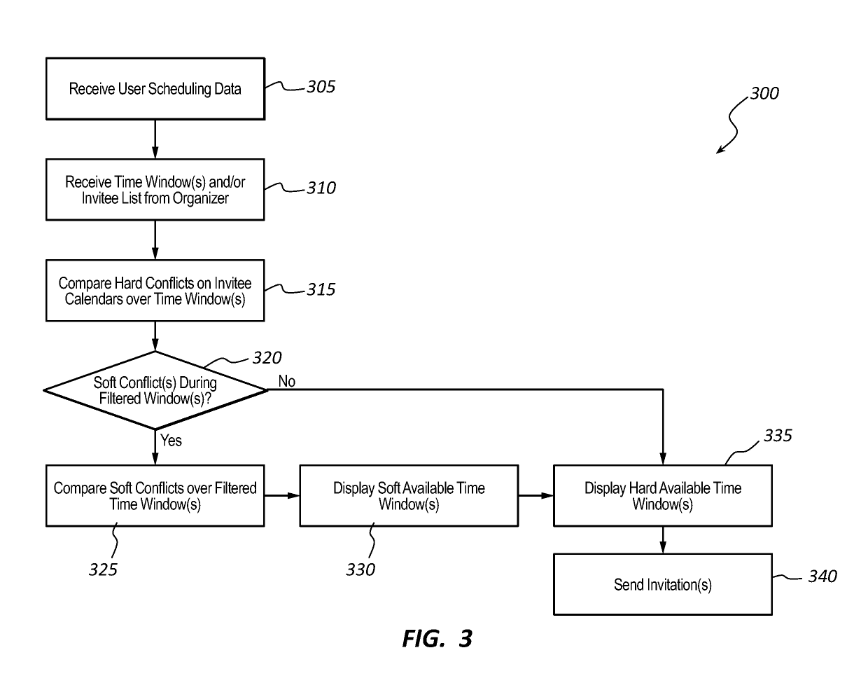

FIG. 3 is a flow chart illustrating a method 300 for collaborative time management according to some implementations. Method 300 may begin at step 305 by receiving scheduling data for one or more users of a system, which may comprise various client/user devices and one or more servers, as previously mentioned. Examples of scheduling data received or otherwise obtained include various events on each of the various users' calendars. As those of ordinary skill in the art will appreciate, events, and therefore scheduling data, may be blocked by date, by hours/minutes during the day, or by larger time blocks, such as by weeks or months, as desired.

Upon obtaining and storing user data, method 300 may comprise, at step 310, receiving data from an organizer of a meeting or other event, such as one or more time windows during which the organizer would like to schedule the event, relating to the event. For example, the organizer of the event might select a time window comprising an entire week. In some implementations, certain hours from the week or otherwise from the selected time window(s) may be selected. Preferably, this event data further comprises a list of one of more invitees to the event, such as a group of employees collaborating on a project from within a company, for example.

Upon receiving this data, the system may be configured to compare the one or more invitee calendars during the selected time window(s) to identify conflicts and/or available time slots at 315. In some implementations, step 315 may comprise filtering the time window(s) identified by the organizer to identify any shared available time window(s). Although step 315 as depicted in FIG. 3 comprises comparing conflicts, it should be understood that alternative implementations are contemplated in which conflicts are compared without regard to their firmness/flexibility.

However, in embodiments in which the flexibility of the conflicts is considered, method 300 may then comprise determining whether there are any soft conflicts during the filtered time window(s) identified in step 315 at step 320. Thus, for example, if the organizer initially identified an entire week as the potential time window for an event, and the filtered time slots or shared free time windows during this time period in which all invited users lack a conflict (in some embodiments/implementations, a hard conflict) are Tuesday from 2-3 pm and Friday from 9-11 am, the method may comprise searching these two time windows for soft conflicts amongst the various invitees. If there are no soft conflicts during these time windows, method 300 may proceed to step 335, which may comprise displaying the shared available time window(s) to the organizer.

If, on the other hand, there are soft conflicts during the filtered time window(s) at step 320, method 300 may proceed to step 325 at which point the various soft conflicts during the filtered time window(s) may be compared to further filter the filtered time window to obtain both “soft available” time window(s) and “hard available” time windows. “Soft available” time windows may comprise time windows that could be available for the event but require some rescheduling of one or more of the invitees. “Hard available” time windows may comprise time windows that lack any conflicts whatsoever and therefore should be available for the event without the need for rescheduling.

In implementations comprising consideration of both hard and soft conflicts, method 300 may therefore comprise displaying the soft available time window(s) at 330 and the hard available time window(s) at 335. Method 300 may then comprise receiving (from the organizer) and/or sending (to the invitee(s)) an invitation to the event at 340. In some implementations, step 340 may comprise sending multiple invitations to allow the invitees to select amongst the available time window(s). Alternatively, step 340 may comprise receiving a specific time window from amongst the available time window(s) from the organizer and sending a specific invitation corresponding to this request to the invitee(s).

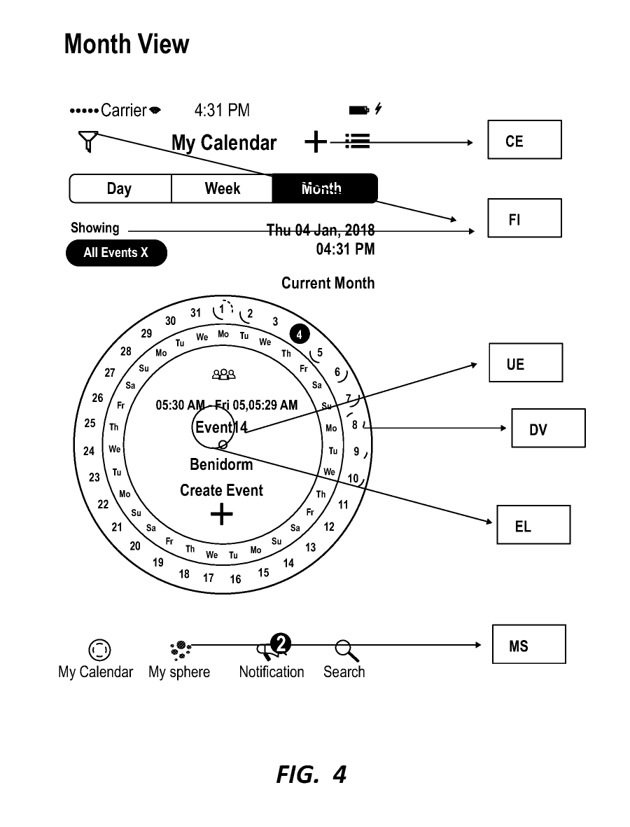

FIG. 4 is a screenshot of a “month view” of a user interface for implementing one embodiment of a collaborative time management system. As shown in this figure, in preferred embodiments, the user interface may comprise a circular time display. The circular display may comprise three concentric (or, in other embodiments, two or more than three) circular displays. In the depicted embodiment, the outer circle comprises dates/days for a month view. As discussed below, in other views, the outer display may comprise other information, such as times of the day. The internal circular layer of the month view of FIG. 4 comprises days of the week, each of which may be aligned with a particular date on the outer circle/layer. In addition, information for a selected date and/or time may be displayed inside the circle, as also shown in FIG. 4. Preferably, the view automatically adjusts based upon the number of days in a month when navigating from one month to another and/or allows for user selection between various views, including, for example, year, month, week, day, and/or other views of a desired time frame.

Various other aspects of the user interface are also shown in FIG. 4, one or more of which may be configured to allow for user manipulation in order to change the display, create events, filter events, etc. For example, an icon, such as a plus symbol (“CE” on FIG. 4), may be displayed, which, upon being touched or otherwise activated by a user, may result in the creation of a new event. This creation may lead to one or more of the steps referenced in the method of FIG. 3.

Similarly, another icon, such as the funnel or filter icon shown in FIG. 4 (“FI” on FIG. 4), may result the filtering of a listing of existing events. Such filtering may take place based upon a set of predetermined categories, such as by dates/times, or other time frames, by type of event, by participants/invitees, etc.

One or more upcoming event titles (“UE” on FIG. 4) or other event labels may be displayed on the user interface. For example, each of the events during the particular time frame of the view being displayed (month in the case of FIG. 4) may be displayed. In some embodiments and implementations, the events may be displayed chronologically during the particular time frame of the view being displayed. In some embodiments and implementations, a single upcoming event may be displayed at UE and a list of subsequent events may be displayed at EL.

At “DV” in FIG. 4, it can be seen that, in some embodiments and implementations, a partial view of each day during the month (or each alternative sub-time during the time frame of the view being displayed) may be provided. For example, in the example of FIG. 4, a partial circle may be displayed around each day during the month during which items on the schedule appear. This may be useful to allow a user to have a general indication of the availability, or lack thereof, of each particular day during the month (or day during the week, hour during the day, etc.). In some embodiments and implementations, by pressing on a particular date, a day view, such as the day view shown in FIG. 6 and discussed below, may be displayed in place of the month view of FIG. 4.

A list of additional icons may be displayed on the user interface, as indicated at the bottom of FIG. 4, selection of each of which may result in display of another screen, aspect, and/or function of the system. For example, as indicated at MS, some embodiments and implementations may comprise a display consisting of the display of all contacts and/or groups/subcontact lists. Similarly, notifications, chats, searches, etc., may be provided for, as described in greater detail below.

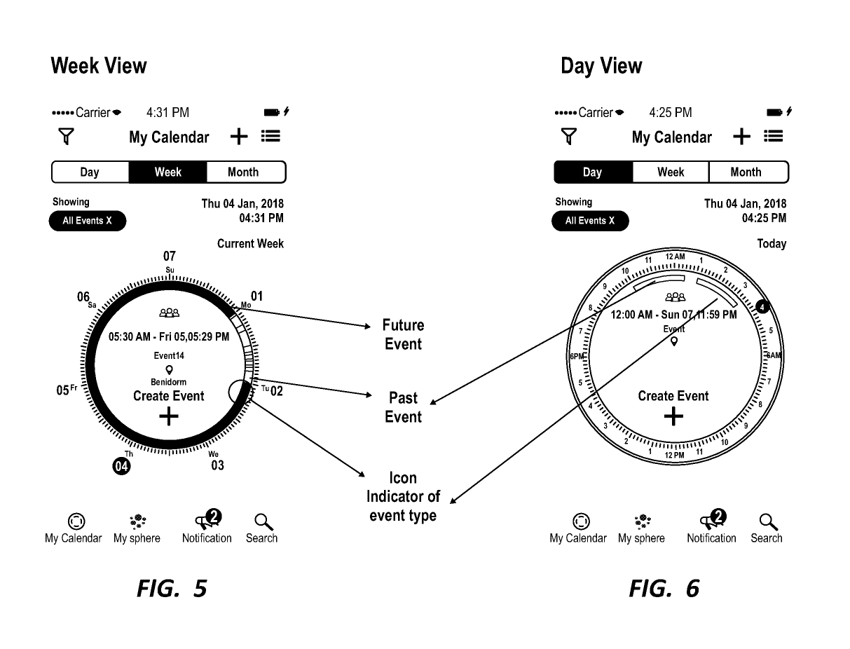

FIG. 5 is a screenshot of a “week view” of a user interface for implementing one embodiment of a collaborative time management system. As shown in this figure, again, a circular/concentric time display may preferably be used. Transfer from the month view of FIG. 4 to the week view of FIG. 5 may take place, for example, by selecting the “week” icon near the top of the user interface.

In the depicted embodiment, past events may be distinguished from future events by, for example, providing a different color, highlighting, bolding, etc., of a bar or other display item extending about the circular time display. Similarly, events during the week may be indicated by providing lines, “slices,” or other distinct icons or image display distinctions about the circular display. In some embodiments and implementations, event types may be distinguished based upon use of different colors or any other suitable display difference. Similarly, the length of the events may be indicated by the “thickness” of the slice in the circular display. Each of the various dates during the week may be displayed on the outer perimeter or circle of the display, which may consist of days of the week, dates of the month or, as shown in FIG. 5, both. The display may transition from the week view of FIG. 5 to the day view of FIG. 6 by, for example, selecting a particular day and/or date along the outer perimeter and/or by selecting one of the day/week/month icons near the top of the display.

Various alternative implementations are contemplated. For example, the “week view” display may comprise a view having seven days, as shown in FIG. 5, or may comprise a view having 14 or 15 days, as shown in FIG. 14, which is discussed below.

FIG. 6 is a screenshot of a “day view” of a user interface for implementing one embodiment of a collaborative time management system. As with other screens of the user interface, past events may be distinguished from future events by, for example, providing a different color, highlighting, bolding, etc., of a bar or other display item extending about the circular time display. Similarly, events during the day may be indicated by providing lines, “slices,” or other distinct icons or image display distinctions about the circular display. Again, event types may be distinguished based upon use of different colors or any other suitable display difference.

In some embodiments and implementations, the day view may comprise a circular design with 24 spread in a first circle, such as an outer circle, and an inner layer/circle dividing the day into various divisions, such as by ten-minute increments, for example, using tick marks or other suitable display items. In some embodiments and implementations, two different sets of colors or other suitable display items, such as bolding, use of alternative icons, tick mark thicknesses, etc., may be used to represent sunrise and sunset based on the time and location of the user. In the depicted embodiment of FIG. 6, a user can decipher an approximate sunrise and sunset by virtue of red tick marks during the daytime and black tick marks during the nighttime. Of course, a variety of alternative options will be apparent to those of ordinary skill in the art after receiving the benefit of this disclosure. For example, the day may be broken up between working hours and non-working hours rather than by daylight if desired.

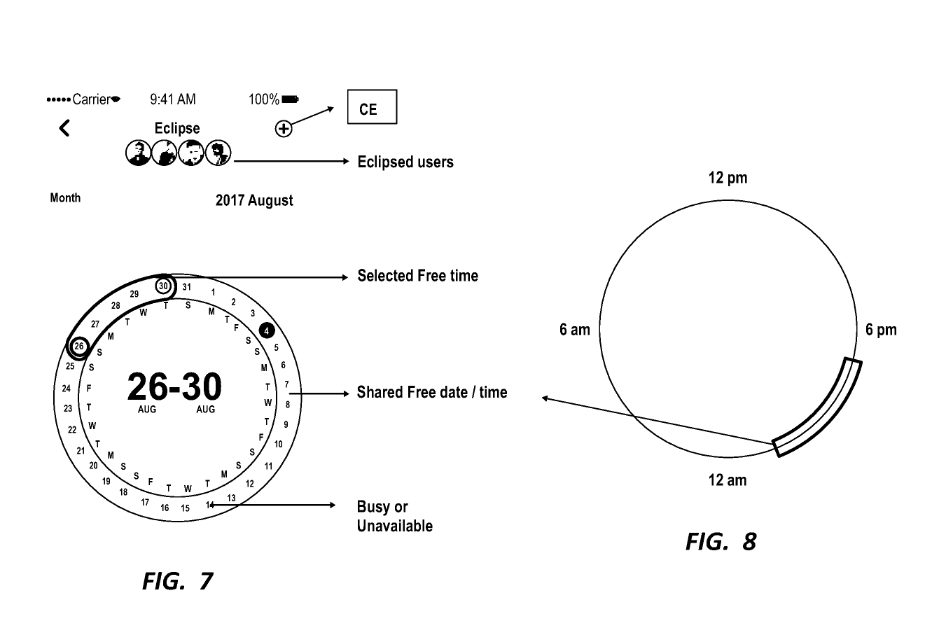

FIG. 7 is a screenshot of a scheduling or shared free time view of a user interface for implementing one embodiment of a collaborative time management system. This screen may be referred to as the ECLIPSE view. As previously mentioned, the functionality associated with this screen may allow for the automated determination of shared free time of all users in a group or subgroup, such as all users within a company or other organization or all users selected by an organizer for a particular event, and may display available date/time slots based on the requested time, duration, and/or other desired parameters.

As shown in FIG. 7, the user interface may display a series of icons, such as images of the users, in a list of “eclipsed users.” One or more selected time frames (such as selected by an organizer, for example) may be displayed on the display. For example, in the depicted embodiment, the selected free time may be displayed by highlighting one or more time frames. In the display of FIG. 7, several consecutive days are highlighted by a band extending in a semi-circle about the circular time display. Similarly, in the screenshot of the scheduling or shared free time view of FIG. 8, various consecutive hours during a particular day are highlighted by a similar band about the circular day view. This display feature may be used to, for example, display/select time frames for a possible event, display shared available free dates/times for an event, and/or allow a user to select unavailable times/dates.

As also shown in FIG. 7, the availability or potential availability of each of the various users that have been or may be invited to a particular event may be displayed as well. For example, busy or unavailable times/dates may be indicated by using grayed out or otherwise distinct fonts. In some embodiments and implementations, information regarding “hard unavailable” and “soft unavailable” times/dates may also be displayed. For example, soft unavailable time frames may be displayed using a first font, color, or other display parameter, and hard unavailable time frames may be displayed using a distinct, second, font, color, or other display parameter. This may allow an organizer to easily visualize the availability, or potential availability of a predetermined group of users/invitees to facilitate ease of scheduling.

Events/conflicts that are “hard” may be categorized/determined based on user parameters such as time, location, user preferences, type of event and other parameters and cannot, or should not, be requested for a change. Events/conflicts that are “soft” may be categorized/determined by similar parameters and may be considered events/conflicts that may be subject to change.

For example, users may be allowed to specifically label events as either “hard” or “soft” or may be able to more precisely label the flexibility of the event by use of, for example, a numerical scale. Similarly, events may be automatically categorized as hard or soft by location. In other words, events that are in a different location, or further than a predetermined (in some cases, user determined) distance, from the location of the event for which an eclipse/invitation is requested may be configured to automatically label an event as hard/soft, or otherwise according to its flexibility. In some embodiments and implementations, users may be allowed to set and/or change the parameters that will categorize an event as hard/soft or otherwise categorize its flexibility.

As yet another example, the type of event may be used, automatically and/or with user selection/interaction, as hard/soft, etc. For example, an event categorized as official or important or unavoidable may automatically be categorized as a hard event. In some embodiments, learning algorithms and/or artificial intelligence may be used to label/categorize events according to their flexibility automatically based upon previous experience with event scheduling. For example, the system may be configured to adapt/learn over time and provide intelligent suggestions and/or prompts based on criteria such as user activities, user locations, user preferences, event types, and/or user interests (either learned interests or preselected interests). These suggestions or prompts may be taken, for example, through a chat or other communication channel, as previously mentioned, thereby enabling smart time scheduling and utilization.

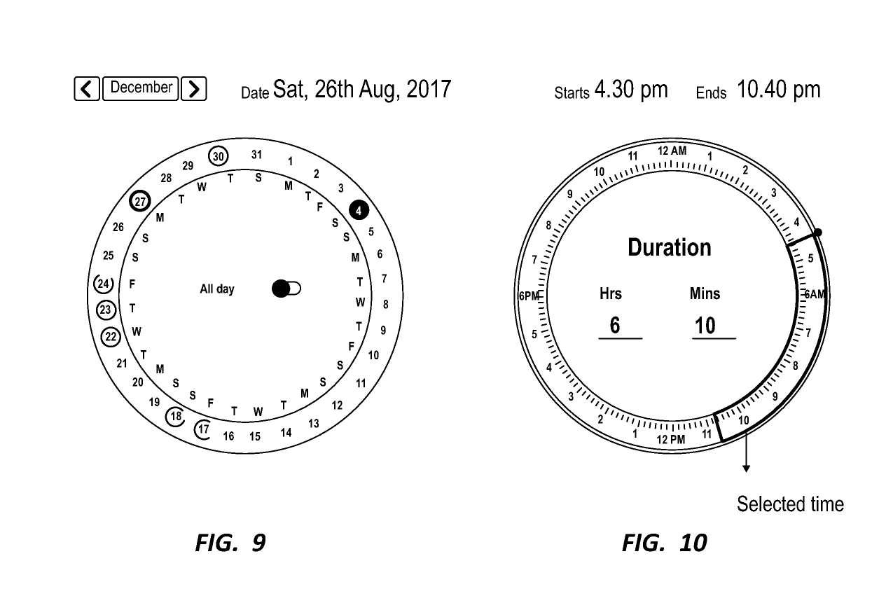

FIG. 9 is a screenshot of a “date picker” view of a user interface for implementing one embodiment of a collaborative time management system. As shown in this figure, this view may again comprise a circular view of a month or other suitable time frame but may further include functional options to navigate and/or select, such as between all day (24 hours) and partial day (work day, for example) views. By selecting a particular date, some embodiments may automatically change the display to the “time picker” display of FIG. 10.

Time picker is, again, a circular view of a selected day/date, and may display the day/date with duration in hours and/or minutes inside the circular view, as shown in FIG. 10. A particular time or time frame may be selected by, for example, tapping on a beginning time and an end time or holding on a start time and dragging to a suitable end time. The selected time frame(s) may then be displayed by, for example, highlighting the selected time as shown in FIG. 10.

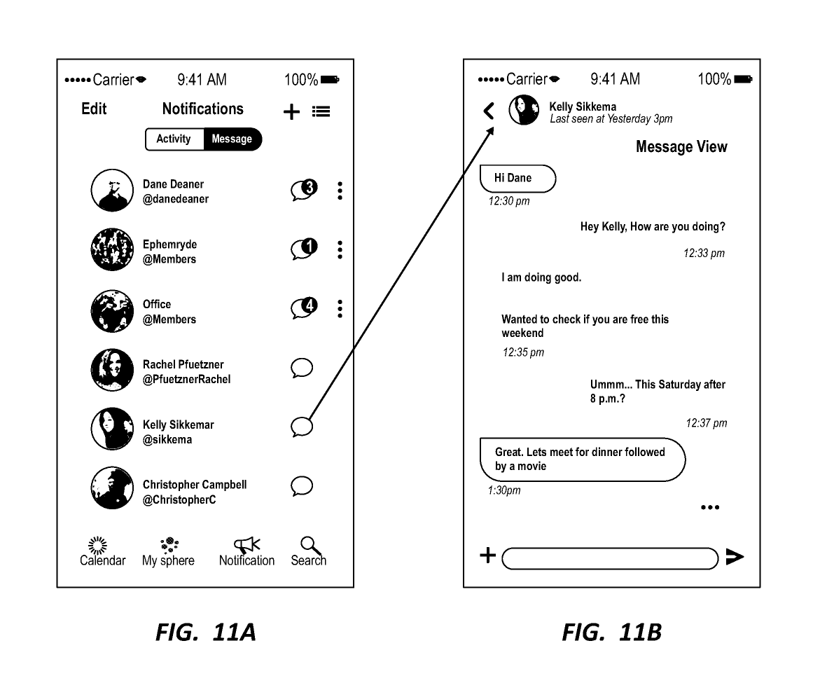

Various other features/elements may be provided in certain embodiments. For example, FIG. 11A is a screenshot of an event-based communication user interface for implementing one embodiment of a collaborative time management system. This display may include all users who are scheduled to participate in a particular event and may therefore facilitate communication with only invited and/or confirmed participants of a particular event.

FIG. 11B is another screenshot of an event-based communication user interface for implementing one embodiment of a collaborative time management system showing a communication with a particular user who is scheduled to participate in an event. The display of FIG. 11B may result from a selection of a particular user, or a subset of users, from the display of FIG. 11A with whom a particular user or organizer would like to communicate. In some embodiments, event-based communications may be configured to automatically expire and/or be deleted once an event has been completed.

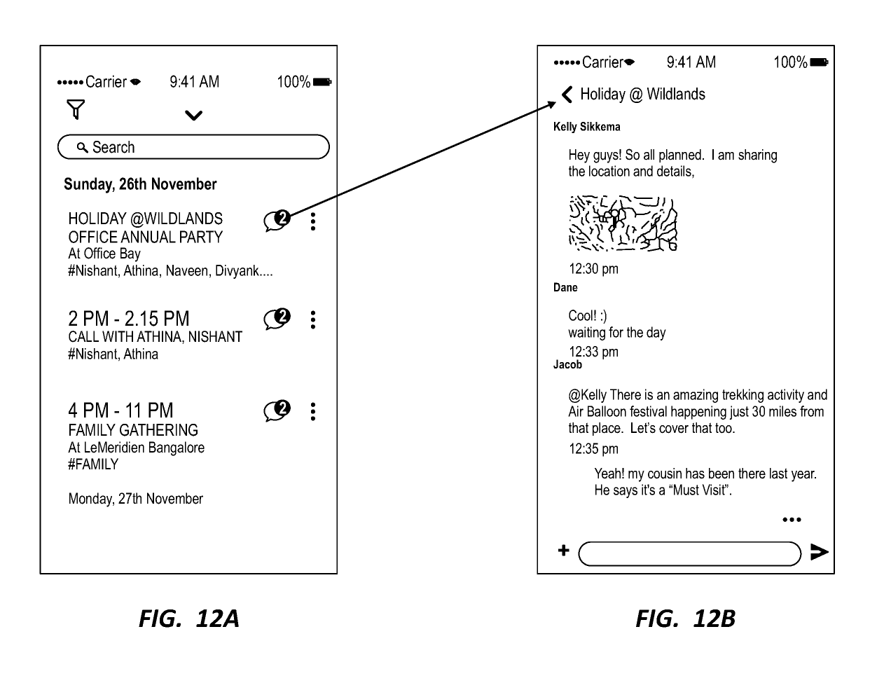

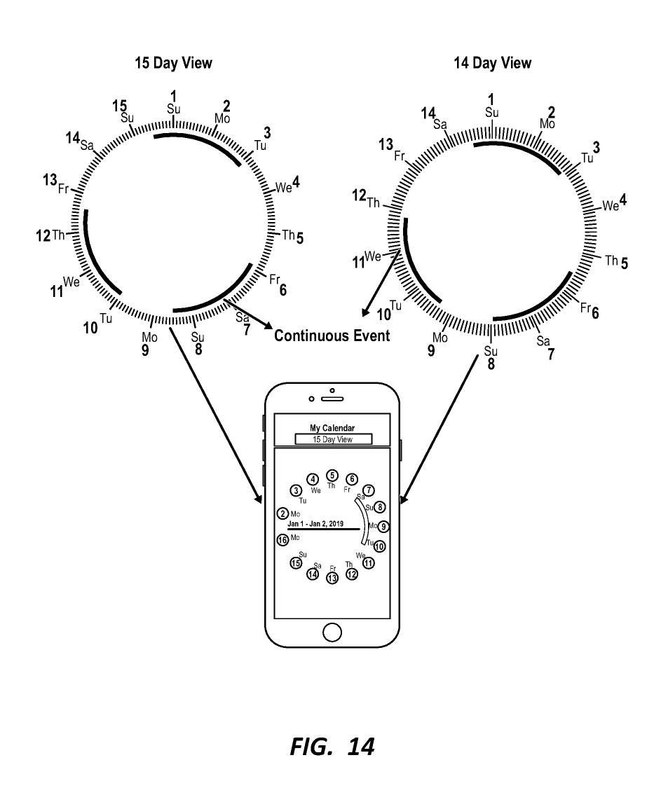

FIG. 12A is a screenshot of a listing of events of a user interface for implementing one embodiment of a collaborative time management system showing communications based upon each event in the listing of events. This display may include a list of upcoming events for a particular user. By selecting a particular event, a group communication associated with that event, such as the display of FIG. 12B, may be displayed. In some embodiments, the display of FIG. 11A may result from the selection of a particular event on the display of FIG. 12A. In this manner, a user may be able to see all of the users associated with a particular event and choose to communicate with all of them, as shown in FIG. 12B, or a single user, as shown in FIG. 11B, or a desired subset of such users, as desired.

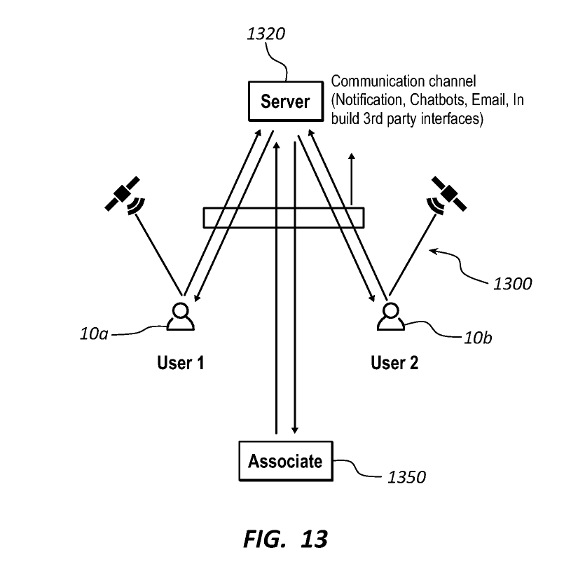

FIG. 13 is a schematic diagram of a system 1300 for collaborative time management according to some embodiments comprising an interface with a third-party associate 1350. System 1300 may comprise a plurality of users, such as users 10a and 10b, as previously mentioned. These users may each have software, such as a mobile or web-based application, that is communicatively coupled with a server 1320 (or multiple servers), as also previously mentioned. Unlike the previous embodiments discussed, however, system 1300 may be configured to communicate with one or more third-party associates of the entity running system 1300, such as third-party business partners offering additional solutions/services.

More specific examples of such associates 1350 include third parties offering advertisements or other business offerings based upon the particular type of event and/or location of event and/or user. For example, system 1300 may be configured to interface with a series of business partners 1350 each of which may provide details about hotels, restaurants, or other options at the location of an event scheduled by one or more users of system 1300.

Location information may be provided, either by system 1300 or one or more associates 1350, such as by GPS functionality, which may be used to track users and/or trigger notifications and/or service offerings in accordance with user locations and/or information associated with upcoming events.

In some embodiments and implementations, associates 1350 may be allowed to participate in chats or other event-based communications. For example, certain third parties may be allowed access to information about events for which their products and/or services may be relevant, and/or which may be located in their proximity. Such third parties may be allowed, in some cases based upon paid subscriptions, to issue communications regarding products and/or services that may be relevant to one or more particular events.

FIG. 14 depicts three additional screenshots of a user interface for implementing some embodiments of a collaborative time management system. Both 14- and 15-day view options are depicted in FIG. 14. The dates may be arranged in circle and may provide a visual indication of events during the time frame displayed. The dates may start on a horizontal axis, as indicated in the central image of FIG. 14, or may start on the top, as shown in the upper two images of FIG. 14, or otherwise as desired.

As previously mentioned, events may be depicted by lines, bars, or other visual icons preferably extending about the circular display to an extent corresponding with the duration of the events. Similarly, types of events may be distinguished based upon color, intensity, and/or thickness of the lines/bars, or otherwise. As also shown in FIG. 14, tick marks may be used to delineate sub-time frames, such as hours or blocks of hours within each individual day.

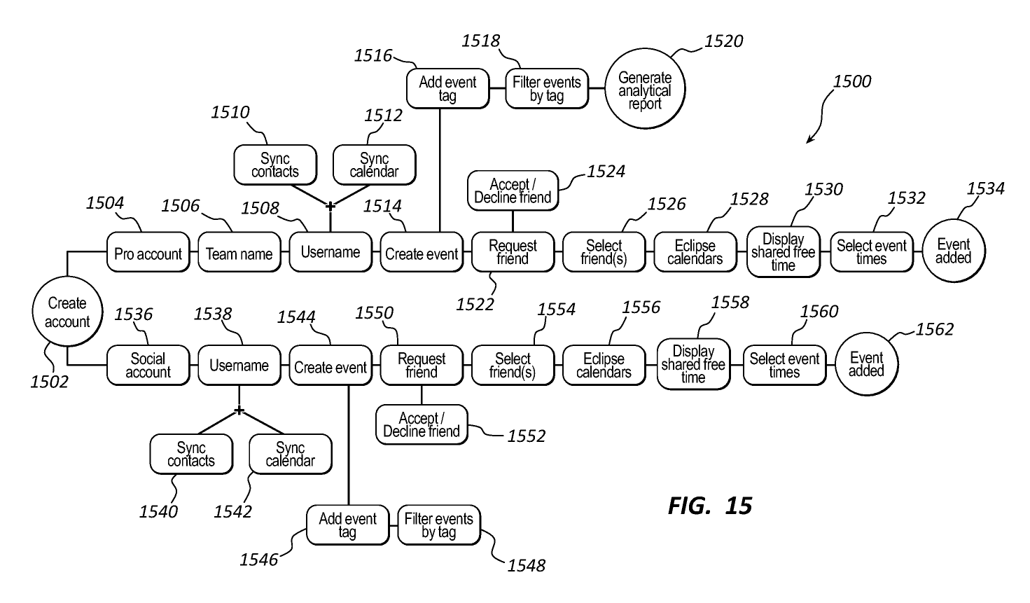

FIG. 15 illustrates another method 1500 according to other implementations. Method 1500 begins at step 1502 where one or more users create an account. As mentioned above, each of the users may, but need not be, part of a particular company, organization, or group. Preferably step 1502 comprises setting up credentials and/or biometrics to allow for identity verification.

In some implementations, multiple account options may be provided. Thus, method 1500 may branch from step 1502 to either step 1504 at which point a professional account may be selected or step 1536 at which point a social account may be created. Of course, those of ordinary skill in the art will appreciate that a wide variety of options are possible. For example, one or more of the account options may be a free account and one or more may be a paid account. In the particular implementation depicted in FIG. 15, the professional account may be an account that is linked with the user's employer and/or another professional company or organization. Similarly, following the social account path at 1536 may result in the creation of a more general account for interacting with friends and family, for example.

Along the professional account path stemming from step 1504, a team or group name may be created or selected at step 1506. This may comprise, for example, a sub-group within a company or organization, such as a group of employees working in a particular division or working on a particular project. A user name may then be created at 1508. In some implementations, the user may be allowed to sync various data elements from another social network, application, locally-stored data, or the like, such as syncing contacts at 1510 or other calendars at 1512. It should be understood that one or more of these preliminary steps will likely only be performed once and then other steps may be performed without the preliminary steps during subsequent use of the system.

A user may be allowed to create one or more events beginning at 1514. Creating an event may comprise creating an event that may include invitees and/or events just for the user creating the event. One or more event tags may be added at 1516. Event tags may comprise, for example, any keyword, group of words, phrase, and/or symbol that help to define, characterize or provide information about the event to allow other users to find the event and/or interact with other invitees and/or participants in the event. For example, an event tag may comprise a category for the event (e.g., sporting event or concert), an action expected to take place during the event (e.g., eating, drinking, working on a project, etc.), a date and/or time period for the event (e.g., Christmas, summer, or lunchtime), or other invitees or other participants in the event. These event tags may be processed using metadata within the system.

Once the tags have been added, users may filter events by tags and/or keywords at 1518. For example, a user may be allowed to select one or more of a preset list of tags or may be able to perform more generic searches of tag data to identify events. Providing event tags and/or metadata may allow, in some embodiments and implementations, a user to generate analytical reports relating to events on a calendar/schedule at 1520. For example, a user may want a report showing all of the events of a particular type (committee meetings, for example) that took place in the past six months, or those currently scheduled for the following month.

The system may also allow for linking various users together. For example, a friend/contact request may be made at 1522, and may be accepted or declined by the invited user at 1524.

Users may then be allowed to link or “eclipse” one or more time periods of their shared calendars. Thus, one or more friends may be selected at 1526. Step 1526 may comprise selecting friends and/or invitees for being invited to a specific event or, alternatively, may comprise simply selecting one or more friends to view shared calendar time during one or more time frames for other reasons, such as simply viewing availability for a less formal purpose, such as dropping in for an impromptu meeting or visit.

At step 1528, the calendars of two or more users may be linked together or “eclipsed” during one or more selected time periods. In implementations in which an event is created by an event organizer, after inputting the requisite information about the event, including one or more desired times for the event and event invitees, each of the calendars of the event invitees may be compared during the one or more desired time frames.

One or more users, such as only the event organizer/inviter in some implementations, may then be sent a visualization, such as one or more of the images presented in the accompanying drawings and/or discussed herein, that provides a visual indication of the availability of the invitees for the event, at 1530. As previously mentioned, in some embodiments and implementations, this visualization may comprise features that allow a user to determine unavailable times, soft shared available times, and fully-open shared available times.

A user, such as the event organizer, may then select one or more of the available times for the event at 1532. Upon selecting the event time, each of the invitees may be sent an invitation for the event and, upon confirmation and/or acceptance of the invitation, the event may be added to each of the accepting invitee's calendars at 1534. Alternatively, the event may be simply placed on each of the invitee's respective calendars without requiring acceptance.

Following the social account path 1536, a similar set of steps may take place. Thus, for example, a user name may be created at 1538 and contacts and/or calendars may be synced at 1540 and 1542, respectively. Similarly, an event may be created at step 1544 and, if desired, event tags may be added at 1546, which, as previously mentioned, may allow other users to filter events by tag at 1548. As also previously mentioned in connection with the professional account, friends may be requested, accepted/declined, and/or selected at 1550, 1552, and 1554, respectively.

Other similar steps for automated comparison of user's calendars for shared available time, preferable including available, soft available, and unavailable times, may then be performed. Thus, the calendars of a plurality of users may be compared at 1556, preferably during one or more selected time periods, to make scheduling an event simpler for the organizer. The results may then be delivered to the user, preferably by way of one or more visualizations comprising non-textual images (textual information such as date/time numbers may be provided along with the non-textual imagery in some embodiments), at 1558. In preferred embodiments, however, the non-textual information may be used to derive the availability of the invitees for the event during one or more time periods. In other words, in such preferred embodiments, the textual information standing alone, if provided, would be insufficient to inform the user about the availability of the users/invitees. This may improve the ability of a user, such as the event organizer, to readily view and digest the information being conveyed.

As with the professional account branch, one or more times for the event may then be selected at 1560 and added at 1562.

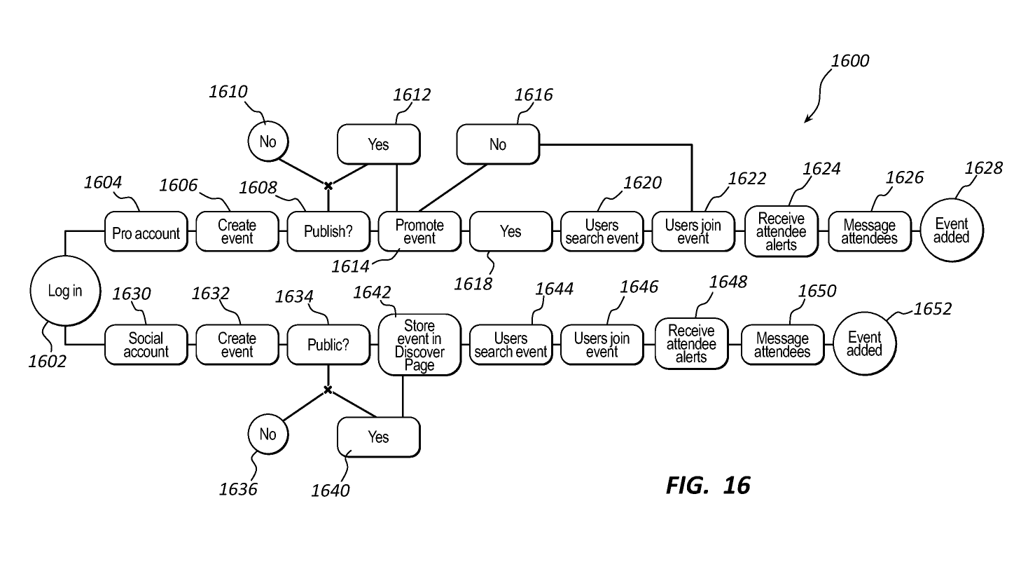

FIG. 16 illustrates another flowchart of a method 1600 that would more typically be performed after an account has been established. Method 1600 begins at step 1602 by logging into the system, preferably by entering suitable credentials to verify identity. For the professional account (1604), an event may be created at 1606. In some implementations, the event organizer or another user may then be allowed whether to make the event public at 1606. In this context, “public” may mean available to the entire organization or more broadly to the public at large. For example, in some implementations, a user may wish to advertise an event to draw interest. In other implementations, a user may wish to keep the event private, which may mean only the invitees to the event are informed of it.

If the user elects not to make the event public, the method may end at 1610. Of course, in some implementations, the user may then view a visualization comprising a compilation of each of the users' calendars during one or more selected time frames, send invites, confirm invites, or any of the other steps discussed herein following step 1610.

If the user elects to make the event public at 1612, another inquiry may be made as to whether the user would like to promote the event at 1614. If not, method 1600 may proceed to step 1622 at which users may be allowed to join the event, or request to join the event, at 1622. If the user desires to promote the event (1618), which may carry a separate promotional fee, the method may proceed by allowing users to search the event at 1620. Other steps/features may be provided in this path. For example, in addition to or as an alternative to allowing other users, or the public at large, identify the event in a search, the event may be listed on a promotional listing, page, spot, or the like.

At 1624, one or more alerts may be sent to the invitees and/or attendees. For example, an alert may be generated for each of the invitees that has accepted the invitation and will therefore be attending the event. As another example, each of the invitees and/or attendees may be sent alerts regarding updates to the event, such as an updated venue, time, or other aspect of the event.

At 1626, the attendees may be able to chat with each other about the event. The communications about the event may be limited to only to the invitees and/or confirmed attendees, or may be open to a larger audience as desired. The event may be added at 1628.

Use of a social account 1630 may be similar in many respects. Thus, an event may be created at 1632 and a similar inquiry made at 1634 as to whether the event should be private (1636) or public (1640). If public, the event may be placed in a database, such as a “Discover Page,” to allow other users to search 1644 for the event and discover its particulars. Users may then join the event at 1646, after which the user may receive a set of notifications or alerts at 1648 regarding the event. Similarly, messaging between attendees or, in some implementations, members of a larger community, such as other users of the system who are not schedule to attend the event, may then chat or otherwise communicate with each other regarding the event at 1650. The event may be added at 1652.

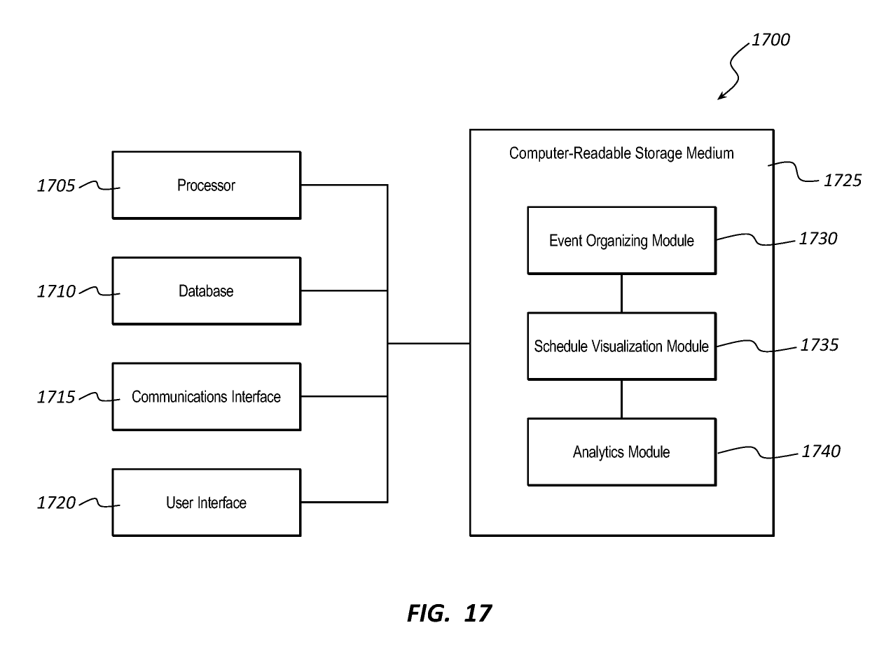

Another example of a system 1700 for collaborative time management is shown in the schematic diagram of FIG. 17. System 1700 comprises one or more computing devices, such as servers, each of which may comprise a processor 1710, a communications interface 1715, and a user interface 1720. Thus, the computing device(s) is configured to communicate with a plurality of user devices, such as mobile devices on a mobile application, or other users on a computer, tablet device, or the like.

System 1700 may further comprise a database 1710, which may be configured to store data records for a plurality of users associated with the plurality of user devices, the data records comprising event schedules for one or more of the plurality of users. A computer-readable storage medium 1725 may be used to store programs and other data for use and execution by the processor 1705, such as various modules discussed below. The system memory/storage medium and/or database may include random access memory (“RAM”), non-volatile memory (“ROM”), and/or one or more bulk non-volatile non-transitory computer-readable storage mediums (e.g., a hard disk, flash memory, etc.).

Communications interface 1715 may comprise a network interface for communicating with other systems via one or more network connections using one or more suitable communication technologies.

User interface 1720 may comprise a display and/or one or more input/output devices such as, for example, a touchscreen, a keyboard, a mouse, a track pad, and the like. System 1700 may further comprise and one or more busses for communicatively coupling the various elements of the system.

Computer-readable storage medium 1725 may comprise various functional modules, such as event organizing module 1730, which may be configured to receive a request for scheduling an event from an event organizer and to compare event organizing data within the request comprising one or more time windows and one or more event invitees for the event with data records for one or more event invitees, which may comprise calendar and/or event information, and to identify one or more shared available time windows for the event.

In preferred embodiments, event organizing module 1730 is configured to compare at least two types of scheduled events for at least one of the plurality of user devices, such as hard scheduled events for each of the event invitees that cannot be rescheduled and soft rescheduled events for each of the invitees that may be rescheduled.

Computer-readable storage medium 1725 may further comprise a schedule visualization module 1735 configured to generate a visualization comprising an image from which any shared available time windows for the event can be derived. Preferably, although textual information may be included with the visualization/image, an event organizer/user may be able to derive basic information about the available time windows without use of the textual information. For example, by arranging visual features around a circular display, as described above, which may correspond to a clock, days of the week, or months of the year, for example, a user may be able to at least generally determine available time slots from the non-textual imagery alone.

In preferred embodiments, visualization module 1735 is configured to generate a visualization from which information may be derived regarding any unavailable time windows, any soft available time windows, and any available time windows for the event.

Computer-readable storage medium 1725 may further comprise an analytics module 1740, which may be configured to receive a request for an analytics report from a report requesting user and generate an analytics report comprising data relating to a plurality of prior events for the report requesting user. For example, a user may wish to generate a report of all meetings attended with another particular co-worker within the last year.

Some embodiments may comprise various other modules, such as a messaging module configured to allow each of the one or more event invitees and/or confirmed attendees to send messages relating to an event.

As used herein, a software module or component may include any type of computer instruction or computer executable code located within a memory device and/or m-readable storage medium. A software module may, for instance, comprise one or more physical or logical blocks of computer instructions, which may be organized as a routine, program, object, component, data structure, etc., that perform one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Furthermore, embodiments and implementations of the inventions disclosed herein may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments and/or implementations may also be provided as a computer program product including a machine-readable storage medium having stored instructions thereon that may be used to program a computer (or other electronic device) to perform processes described herein. The machine-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions. Memory and/or datastores may also be provided, which may comprise, in some cases, non-transitory machine-readable storage media containing executable program instructions configured for execution by a processor, controller/control unit, or the like, of a computer or other computing device, such as a mobile smartphone.

The foregoing specification has been described with reference to various embodiments and implementations. However, one of ordinary skill in the art will appreciate that various modifications and changes can be made without departing from the scope of the present disclosure. For example, various operational steps, as well as components for carrying out operational steps, may be implemented in various ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present invention should, therefore, be determined only by the following claims.

1. A method for facilitating collaborative time management by interacting with data sets, the method performed by a system comprising a processor and a non-transitory computer-readable storage medium storing instructions that, when executed, cause the processor to perform the method, the method comprising the steps of:
receiving schedule data from a plurality of users, wherein the schedule data comprises one or more scheduled events for each of the plurality of users and time periods associated with the one or more scheduled events;
receiving event organizing data for an event from an event organizer, wherein the event organizing data comprises one or more time windows and one or more event invitees for the event;
comparing the schedule data with the event organizing data to identify one or more shared available time windows for the event; and
transmitting graphical data for display on a computing device, wherein the graphical data comprises an image allowing the event organizer to visualize each of the one or more shared available time windows concurrently on a display screen of the computing device.

2. The method of claim 1, wherein the schedule data comprises at least two types of scheduled events for at least one of the plurality of users, and wherein the at least two types of scheduled events are categorized according to the likelihood of being able to reschedule a scheduled event by a user.

3. The method of claim 2, wherein the at least two types of scheduled events comprises hard scheduled events that cannot be rescheduled and soft rescheduled events that may be rescheduled, and wherein the step of comparing the schedule data with the event organizing data to identify one or more shared available time windows for the event comprises comparing the schedule data with the event organizing data to identify one or more soft available time windows during which one or more of the plurality of users has a soft scheduled event.

4. The method of claim 3, wherein the image allows a user to visualize any unavailable time windows, any soft available time windows, and any available time windows for the event.

5. The method of claim 1, further comprising displaying the image on the computing device.

6. The method of claim 5, wherein the computing device comprises a mobile computing device.

7. The method of claim 1, further comprising generating a circular calendar display for each of the plurality of users, each of the circular calendar displays comprising a visual indication of a respective user's scheduled events for a predetermined period of time.

8. The method of claim 7, wherein the image comprises a circular calendar display comprising a visual indication of each of the one or more shared available time windows.

9. The method of claim 8, wherein the circular calendar display of the image comprises a plurality of concentric graphical features, and wherein each of the plurality of concentric graphical features conveys information relating to a distinct time frame.

10. A method for facilitating collaborative time management by interacting with data streams performed by a system comprising a processor and a non-transitory computer-readable storage medium storing instructions that, when executed, cause the processor to perform the method, the method comprising the steps of:
receiving schedule data from a remote user system, wherein the schedule data comprises one or more scheduled events for each of a plurality of users and time periods associated with the one or more scheduled events;
receiving a request to organize an event from an event organizer;
generating a response to the request, the response comprising a visualization derived from the schedule data and the request, wherein the visualization comprises a single image comprising non-textual information from which any shared available time windows for the event can be derived; and
transmitting the response to a user.

11. The method of claim 10, wherein the step of transmitting the response to a user comprises transmitting the response to the event organizer.

12. The method of claim 10, wherein the step of transmitting the response to a user comprises transmitting the response to a remote computing device.

13. The method of claim 10, wherein the visualization further comprises textual information.

14. The method of claim 10, wherein the image comprises a circular time display.

15. The method of claim 14, wherein the circular time display comprises a plurality of concentric layers from which distinct calendar-related information can be derived.

16. A system for facilitating collaborative time management, comprising:
a computing device comprising a processor, the computing device configured to communicate with a plurality of user devices;
a database configured to store data records for a plurality of users associated with the plurality of user devices, wherein the data records comprise event schedules for one or more of the plurality of users;
an event organizing module configured to receive a request for scheduling an event from an event organizer, wherein the event organizing module is configured to compare event organizing data within the request comprising one or more time windows and one or more event invitees for the event with data records for each of the one or more event invitees and to identify one or more shared available time windows for the event; and
an event schedule visualization module configured to generate a visualization comprising an image from which any shared available time windows for the event can be derived.

17. The system of claim 16, wherein the event organizing module is configured to compare at least two types of scheduled events for at least one of the plurality of user devices, and wherein the at least two types of scheduled events are categorized according to the likelihood of being able to reschedule a scheduled event by a user.

18. The system of claim 17, wherein the event organizing module is configured to compare hard scheduled events for each of the event invitees that cannot be rescheduled and soft rescheduled events for each of the invitees that may be rescheduled, and wherein the visualization comprises a visual indication of any unavailable time windows, any soft available time windows, and any available time windows for the event.

19. The system of claim 16, further comprising an analytics module configured to receive a request for an analytics report from a report requesting user and generate an analytics report comprising data relating to a plurality of prior events for the report requesting user.

20. The system of claim 16, further comprising a messaging module configured to allow each of the one or more event invitees to send messages relating to the event.
